(19) United States
(12) Patent Application Publication
(10) Pub. No.: US 2011/0172333 A1
(43) Pub. Date: Jul. 14, 2011

(54) Methods of producing fiber clay sclupting material, fiber clay products and fiber clay sculpting material

(76) Inventor: Lorri Acott-Fowler, Fort Collins, CO (US)

(21) Appl. No.: 12/655,833

(22) Filed: Jan. 8, 2010

(51) Int. Cl. C08K 7/02; C08K 9/04

(52) U.S. Cl. 524/34; 524/445

(57) ABSTRACT

The present invention involves the creation of fiber clay sculpting material and use of the material as a medium, including techniques for producing the material and non-fired and non-dried clay products. A fiber clay sculptural material is disclosed, while alternative embodiments may encompass fiber clay products. The fiber clay sculptural material in accordance with the present invention may incorporate fiber material such as paper, nylon or fiberglass. One embodiment of the invention disclosed is a method of producing fiber clay sculpting material, featuring the provision of an acrylic emulsion, adding the acrylic emulsion to fiber clay and mixing the acrylic emulsion with the fiber clay to form an acrylic fiber clay sculpting material. A fiber clay product may be produced from the disclosed methods. Further embodiments of the invention are fiber clay sculpting materials made of fiber clay and an acrylic emulsion mixed with the fiber clay to form an acrylic fiber clay sculpting material. The material may be used to from non-fired or non-dried fiber clay products.

### BACKGROUND OF THE INVENTION

Sculpturing techniques for creative works in the medium of clay are generally well known. The present invention is a departure from such traditional techniques and is applicable in the preparation of clay medium, and in some preferred applications, sculpturing of clay. Furthermore, some preferred embodiments are methods of teaching, as well as in the works and products so prepared.

Traditional techniques in sculpting with conventional clay have often encountered problems in their implementation when the clay is allowed to dry before final forming or before the work is fired, such as in a kiln, as the medium becomes fragile and easy to crack. Furthermore, some may consider that conventional clay becomes undesirably dense and heavy when fired. One problem with the use of conventional clay for relatively large structures is that the previously described problems are merely magnified. The work may tend to warp and crack when allowed to dry pre-firing, and even more so if the clay is dried quickly pre-firing.

It may have been traditionally thought that firing is necessary in order to produce a finished work given clay particles are relatively small and are thought not to have structural strength until they are fired. The process of firing may have been thought to be a necessity in order to overcome what may be considered the inherent problems and difficulties in working in traditional clay medium. The above-described deficiencies may have led others to developed new techniques and mediums in which to create preferred sculptural works, while others maintained working in conventional clay and accepting the requirement for firing the work prior to drying of the clay. Those developing sculpting clay techniques have continually perceived the need for more structurally stable clay medium that would not suffer characteristics resulting in fragility in the work prior to firing, a finished work being too dense or heavy, or the lack of sufficient repairability of the work.

One recent development has been in the use of paper clay. Paper clay may be thought to be a clay medium to which cellulose fiber, such as paper, is added that improves the mediums characteristics as a final work when fired. Sources of cellulose may include, but are not be limited to, cotton, linen, flax or wood that is processed into paper. In one example, a clay slip mixture incorporating paper pulp is produced to form an emulsion, an emulsion that when further processed by mixing prior to forming a pre-fired work is ready for firing in a kiln, described for example in U.S. Pat. No. 5,726,111. The resultant fired work is thought to have greater structural strength while also being lighter than fired clay medium works.

The benefits and objectives purported to be achieved in the use of paper clay for fired works appear to confirm the previously recognized requirement for firing a work of traditional clay, and even that of paper clay mediums in order to produce a preferred finished work. Although such traditional developments recognize the inherent difficulties in working with traditional clay, these technologies may have actually taught the requirement for firing paper clay in order to overcome the understood limitations of clay.

Furthermore, some benefits to the use of paper clay have been recognized during forming of the work, as may be understood in U.S. Pat. No. 5,726,111; however, such benefits apparently are directed to the ability to repair and modify a work in dry or wet form, albeit prior to firing, and in allowing for juxtaposed thick and thin areas of the work to have less shrinkage after firing. Other traditional techniques may consider that the paper clay medium need not be fired immediately, but may be later wetted or even repaired during the drying process in preparation for firing.

Non-clay mediums have also been developed, such as the material commonly known as Paperclay® or “Creative Paperclay”, which may be an air-hardened modeling medium, having no clay content, and popular in recreational arts, crafts, and puppet and doll-maker markets. Non-clay mediums may suffer from the lack of repairability once dried and may not be suitable for larger or more intricate works requiring a more structurally-stable medium. Non-clay mediums may not be the medium of choice for some artists, wherein some sculptural works are preferentially made of clay given the mediums look, feel, and other aesthetic characteristics.

Other additives may have been previously considered for clay mediums, in the formation of clay-based materials and structures; however, paper clay is traditionally recognized as a preferred additive for fired sculptural works that allows preferred forming, repair and post-firing characteristics. These alternative additives may actually lack certain properties that may be found in paper clay medium.

The present invention seeks to overcome one or more of these and other deficiencies of the prior art.

### SUMMARY OF THE INVENTION

The present invention seeks to provide for, address and overcome one or more objectives or deficiencies of the prior art.

Accordingly, the present invention are techniques involving the creation of clay products incorporating fiber clay and even in the preparation of fiber clay mediums as a component material thereof, and including techniques for producing a non-fired clay product having fiber clay as a material. Preferred embodiments of the invention may be directed to fiber clay sculpting material and products incorporating fiberclay and acrylic polymer emulsion, while alternative embodiments may encompass other clay products incorporating fiber clay. Alternative embodiments may incorporate additive materials such as nylon fiber, even materials other than cellulose fiber, and achieve the objects identified above and those presented herein as well as other objects and advantages of the invention.

The present invention involves techniques in the creation of clay products incorporating fiber clay as a medium, including techniques for producing a non-fired fiber clay product. Preferred embodiments may encompass clay products generally. The fiber clay medium in accordance with the present invention may incorporate fiber material such as paper, nylon or fiberglass. The present invention diverges from traditional thought and use of paper clay, not only in diverging from traditional requirements of firing paper clay, but expanding the use of clay with other added materials. In accordance with the present invention, clay having fiber materials including but not limited to cellulose fiber are advantageously utilized in a broader understanding and application of clay with fiber as a medium.

One embodiment disclosed are methods of producing a fiber clay sculpting material, comprising the steps of providing an acrylic emulsion, adding the acrylic emulsion to fiber clay; and mixing the acrylic emulsion with the fiber clay to form an acrylic fiber clay sculpting material. Fiber clay sculpting material is also disclosed comprising fiber clay and an acrylic emulsion mixed with the fiber clay to form an acrylic fiber clay sculpting material. The fiber clay sculpting material may be a sculpting material to form a non-fired fiber clay product, or to form a non-dried fiber clay product, in accordance with the present invention.

Fiber clay products produced in accordance with the present invention and as embodiments of the present invention are also disclosed. Additional embodiments of the invention further comprise methods of teaching the production of a non-fired fiber clay sculptural work having the steps in one embodiment of the invention of: instructing the provision of fiber clay for a sculptural work, instructing the working of fiber clay into a form, instructing the drying of the fiber clay to a non-fired dried clay form, and instructing the creation of the non-fired dried clay form into a non-fired fiber clay sculptural work. A step of mixing of an emulsion into the fiber clay, preferably an acrylic emulsion in some embodiments, is taught in accordance with the present invention.

Other materials may be added to traditional clay in accordance with the features and aspects of the present invention and still be encompassed by and be alternative embodiments to those disclosed in this present application.

Still other apparatus and methods are also disclosed as embodiments of the invention in the present application. The invention achieves techniques that embody and create more structurally stable clay products, such as sculptural works, while avoiding the unnecessary firing of fiber clay that may have been thought previously to be necessary to produce a less fragile work. The present invention accomplishes stable fiber clay products that are also aesthetically pleasing in their design and in their construction process that might only have been previously thought to be accomplished by further firing of paper clay. The present invention also address structural frailties recognized in traditional techniques, such as: the juxtaposition of thick and thin areas of the work thought to have weakened configurations susceptible to cracking; use on and with a frame support or armature that may have been thought to only further weaken and crack dried clay under traditional techniques; and having less warping, deformation and shrinkage than after firing under traditional techniques.

### DETAILED DESCRIPTION OF PREFERRED EMBODIMENTS OF THE INVENTION

The present invention is described in preferred embodiments that address one or more inadequacies of the prior art. Accordingly, embodiments of the invention are shown and described in the Figures, written description, and throughout the disclosure of this application.

In preferred embodiments, a step of mixing of an emulsion into the fiber clay, preferably an acrylic emulsion in some embodiments, is taught in accordance with the present invention. The feature of a mixed in emulsion provides for even greater structural integrity, and provides an all round preferred sculpting medium.

Again, the feature of a mixed in emulsion, and in preferred embodiments an acrylic emulsion, achieves preferred structural integrity, reducing the need for added materials, and provides an all round preferred sculpting medium that is even less brittle and that provides even greater resistance to cracking than traditional mediums. Fiber clay that might be originally intended as a ceramic material to be fired is preferred as a primary forming material with the added feature of the acrylic emulsion. Some preferred embodiments may include the acrylic emulsion mixed into the fiber clay, wherein embodiments incorporating an acrylic emulsion may not require the use of substrate material or binding material.

The fiber clay presented in accordance with the present invention may be any clay having a fiber material. In some embodiments of the invention, the clay may be paper clay; however, embodiments of the invention may incorporate other fibers, even non-cellulose fibers, and in some preferred embodiments the material may be nylon or fiber glass. Furthermore, the acrylic material in preferred embodiments is an acrylic emulsion providing features and advantages of the present invention. For example, an acrylic polymer emulsion adds structural stability and strength to the product to afford a preferred application of and connection with the fiber clay sculpting material, and in some embodiments with a separate binding material to the fiber clay sculpting material, in order to achieve a structurally sound product that might have only thought to have been achieved previously through firing of paper clay.

Again, the invention achieves techniques that embody and create more structurally stable clay products, such as sculptural works, while avoiding the unnecessary firing of paper clay that may have been thought previously to be necessary to produce a less fragile work.

Accordingly, in reference to one embodiment of the invention, fiber clay and an acrylic emulsion is mixed to form an acrylic fiber clay sculpting material. The fiber clay sculpting material may then be used as a sculpting material to form a non-fired fiber clay product, and even to form a non-dried fiber clay product. In preferred embodiments, the wet fiber clay and the acrylic emulsion are mixed. In one preferred embodiment, the acrylic emulsion is 4% to 8% by weight of the total amount of wet fiber clay to which it is added. The emulsion added in accordance with the present invention may preferably be an acrylic polymer emulsion comprised of acrylic polymers suspended in a liquid. The preferred acrylic polymer emulsions are those typically used as mediums for acrylic paint, as they are nontoxic. However, this does not preclude the use of other nontoxic acrylic polymer emulsions as well. The wet fiber clay and the acrylic emulsion may be mixed in accordance with the present invention and further mixed using mixers and mixing procedures that are standard for mixing clay. The fiber clay may first be mixed with water to achieve a preferred consistency creating preferred wet fiber clay. The fiber material used in the clay may in some preferred embodiments be nylon fibers, while in still further alternative embodiments paper fiber may be used. Some preferred embodiments may incorporate nylon fibers of one eighth to one half inch in length, and a percentage of nylon fiber of 2% to 5% by weight.

The method of producing a fiber clay sculpting material may thus be achieved by providing an acrylic emulsion and adding it to fiber clay, mixing the acrylic emulsion with the fiber clay to form an acrylic fiber clay sculpting material. The method may further include the steps described previously regarding mixing parameters and acrylic emulsion type. Further steps in the production of a non-fired fiber clay product may be performed and additional features in the steps previously described may be incorporated consistent with the present invention.

It is further important to note that aspects of the invention are not limited to producing a fiber clay product. Embodiments of the invention may further extend to the preparation of a fiber clay medium for a non-fired fiber clay product, consistent with the embodiments previously described. Accordingly, preparing fiber clay medium can be accomplished by providing fiber clay, mixing the fiber clay with an acrylic emulsion, working the acrylic fiber clay sculpting material into a form, such as a form for a product or sculptural work, drying the acrylic fiber clay sculpting material to a non-fired dried fiber clay form, and preparing the dried fiber clay form for a non-fired fiber clay product. A fiber clay material, such as clay used for sculptural work and even for ceramic applications, may be used.

As can be easily understood from the foregoing, the basic concepts of the present invention may be embodied in a variety of ways. It involves techniques as well as one or more apparatus or device that may provide for the appropriate techniques. In this application, the techniques of the present invention in some embodiments are disclosed as part of the results shown to be achieved by the various devices and several apparatus described and as steps that are inherent to utilization. They are simply the natural result of utilizing the devices, assemblages or several apparatus as intended and described. In addition, while some devices and apparatus are disclosed, it should be understood that these not only accomplish certain methods but also can be varied in a number of ways. Importantly, as to all of the foregoing, all of these embodiments are encompassed by this disclosure.

Further, each of the various elements or steps of the invention may also be achieved in a variety of manners. This disclosure should be understood to encompass each such variation, be it a variation of an apparatus embodiment, a method or process embodiment, or even merely a variation of any element of these. Particularly, it should be understood that as the disclosure relates to specific features of the invention, the words for each feature may be expressed by equivalent apparatus, device or method terms—even if only the function or result is the same. Such equivalent, broader, or even more generic terms should be considered to be disclosed for each element, step, or action. Such terms can be substituted where desired to make explicit the implicitly broad coverage to which this invention is entitled. As but one example, it should be understood that all actions or functions may be expressed as the function itself, a means for taking that action or achieving that function, or as an element which causes that action or has that function. Similarly, each element disclosed should be understood to encompass a disclosure of the action or function which is facilitated by that element.

Any acts of law, statutes, regulations, or rules mentioned in this application for patent; or any patents, publications, or other references mentioned in this application for patent are hereby incorporated by reference. In addition, as to each term used it should be understood that unless its utilization in this application is inconsistent with such interpretation as would be understood by one of ordinary skill in the art from this disclosure, common dictionary definitions should be understood as incorporated for each term and all definitions, alternative terms, and synonyms such as contained in the Random House Webster's Unabridged Dictionary, second edition are hereby incorporated by reference. However, as to each of the above, to the extent that such references, information or statements incorporated by reference might be considered inconsistent with the patenting of the invention, such as contradicting disclosed features ascertained by a reading of these patent documents, such information and statements are expressly not to be considered incorporated by reference and more particularly as not made by the Applicant. Furthermore, as to any dictionary definition or other extrinsic evidence utilized to construe this disclosure, if more than one definition is consistent with the use of the words in the intrinsic record, the claim terms should be construed to encompass all such consistent meanings.

Furthermore, if or when used, the use of the transitional phrase “comprising” is used to maintain “open-end” disclosure herein, according to traditional disclosure and claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

I claim:

1. A method of producing a fiber clay sculpting material, comprising the steps of:
providing an acrylic emulsion;
adding said acrylic emulsion to fiber clay; and
mixing said acrylic emulsion with said fiber clay to form an acrylic fiber clay sculpting material.

2. A method of producing a fiber clay sculpting material as described in claim 1, wherein said step of mixing comprises mixing said acrylic emulsion in an amount of four percent to eight percent by weight of said fiber clay.

3. A fiber clay product produced as described in claim 1.

4. A fiber clay sculpting material, comprising:
fiber clay; and
an acrylic emulsion mixed with said fiber clay to form an acrylic fiber clay sculpting material.

5. A fiber clay sculpting material as described in claim 4, wherein said fiber clay sculpting material comprises a sculpting material to form a non-fired fiber clay product.

6. A fiber clay sculpting material as described in claim 4, wherein said fiber clay sculpting material comprises a sculpting material to form a non-dried fiber clay product.

7. A fiber clay sculpting material as described in claim 4, wherein said fiber clay comprises nylon fiber.

8. A fiber clay sculpting material as described in claim 7, wherein said fiber clay comprises nylon fiber in an amount of two percent to five percent by weight.

8. A fiber clay sculpting material as described in claim 3, wherein said acrylic emulsion comprises acrylic emulsion in an amount of four percent to eight percent by weight.

9. A fiber clay sculpting material as described in claim 3, wherein said fiber clay comprises nylon fiber.

10. A fiber clay sculpting material as described in claim 3, wherein said fiber clay comprises paper fiber.
